(19) United States
(12) Patent Application Publication
(10) Pub. No.: US 2006/0231574 A1
(43) Pub. Date: Oct. 19, 2006

(54) Self-contained pneumatic beverage dispensing system

(75) Inventors: Richard P. Bilskie, Newnan, GA (US); Brian M. Bilskie, Grantville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: B & b Partners

(21) Appl. No.: 11/406,533

(22) Filed: Apr. 19, 2006

Related U.S. Application Data
(60) Provisional application No. 60/672,885, filed on Apr. 19, 2005.

(51) Int. Cl. B67D 5/56; B65D 88/54

(52) U.S. Cl. 222/129.1; 222/334

(57) ABSTRACT

In one embodiment, a beverage dispensing system includes a source of pressurized gas, a water system having a water tank that stores water, and a pneumatic pump driven by gas from the source of pressurized gas to pull water from the water tank into the pump and pushes water from the pump, a carbonator system that creates carbonated water using water from the pump and gas from the source of pressurized gas, and a beverage dispensing valve that dispenses the carbonated water.

### CROSS-REFERENCE TO RELATED APPLICATIONS

This application claims priority to copending U.S. provisional application entitled “Portable Post-Mix Beverage Dispenser Systems and Methods with Application for High Volume and High Source Water Temperature,” having Ser. No. 60/672,885, filed Apr. 19, 2005, which is entirely incorporated herein by reference.

### BACKGROUND

Self-contained beverage dispensing systems have been produced that can dispense beverages without remaining connected to a source of water or electricity. For instance, several beverage dispensing systems, or elements of the systems, have been described in U.S. Pat. Nos. 5,411,179, 5,553,749, 6,021,922, 6,216,913, 6,234,349, 6,253,960, 6,296,153, 6,536,632, and 6,820,763, each of which is entirely incorporated by reference.

Typically, the system includes a water source, a source of pressurized gas, and a source of liquids such as soft drink syrups. The pressurized gas can be used to both drive the water and liquids through the system and to carbonate water for dispensing carbonated beverages from the system. Such a system can dispense carbonated and/or still water beverages, and may be integrated into a delivery vehicle that may be movable, such as a push cart or a motorized cart.

In some cases, carbonation of the beverage may be insufficient and the temperature of the beverage may be too high. Further, the source of pressurized gas may be easily depleted, and it may not be possible to refill the water source while simultaneously dispensing the beverage.

### SUMMARY

In one embodiment, beverage dispensing system includes a source of pressurized gas, a water system having a water tank that stores water and a pneumatic pump driven by gas from the source of pressurized gas to pull water from the water tank into the pump and push water from the pump, a carbonator system that creates carbonated water using water from the pump and gas from the source of pressurized gas, and a beverage dispensing valve that dispenses the carbonated water.

In another embodiment, a system for reducing the temperature of a fluid includes an ice receptacle configured to hold ice, a fluid chamber having a shared surface with the ice receptacle, the shared surface having perforations that place the ice receptacle in fluidic communication with the fluid chamber, and an outlet passage that places the fluid chamber in fluidic communication with an exterior of the system, such that the system is configured to reduce the temperature of fluid placed into the ice receptacle with ice, and to provide the fluid to an exterior of the system using the perforations and the outlet passage.

In another embodiment, a system for reducing the temperature of a fluid includes a first module that includes an ice receptacle configured to hold ice, a first fluid chamber having a shared surface with the ice chamber, the shared surface having perforations that place the ice receptacle in fluidic communication with the fluid chamber, a first outlet passage that places the fluid chamber in fluidic communication with an exterior of the first module, and a second module that includes a second fluid chamber configured to receive the fluid, and a second inlet passage that places an exterior of the second module in fluidic communication with the second fluid chamber, the second inlet passage being configured to connect to the first outlet passage, such that when fluid and ice are placed in the ice receptacle and the first outlet passage is connected to the second outlet passage, the system is configured to reduce the temperature of the fluid and to supply the fluid to the second fluid chamber by allowing the fluid to move over the ice, through the perforations, and along the first outlet and second inlet passages.

### BRIEF DESCRIPTION OF THE FIGURES

The present disclosure may be better understood with reference to the following figures. Matching reference numerals designate corresponding parts throughout the figures, and components in the drawings are not necessarily to scale.

FIG. 1 is a schematic view of an embodiment of a beverage dispensing system.

FIG. 2 is a partial cut-away view of a first embodiment of a water system that can be used in the beverage dispensing system illustrated in FIG. 1.

FIG. 3 is a partial cut-away view of a second embodiment of a water system that can be used in the beverage dispensing system illustrated in FIG. 1.

FIG. 4 is a partial cut-away view of a third embodiment of a water system that can be used in the beverage dispensing system illustrated in FIG. 1.

FIG. 5 is a partial, cut-away view of an embodiment of a carbonator tank that can be used in a carbonator system of the beverage dispensing system illustrated in FIG. 1.

FIG. 6 is a partial, cut-away view of an embodiment of a carbonator system that can be used the beverage dispensing system illustrated in FIG. 1.

FIG. 7 is a partial, cut-away view of the embodiment of the carbonator system illustrated in FIG. 6.

FIG. 8 is a schematic view of an embodiment of a source of liquids that can be used in the beverage dispensing system illustrated in FIG. 1.

FIG. 9 perspective view of an embodiment of a beverage dispensing system, illustrating a serving module and a refill module of the system.

FIG. 10 is a cut-away view of an embodiment of a single stroke pump.

FIG. 11 is a cut-away view of an embodiment of a dual stroke pump.

### DETAILED DESCRIPTION

Described below are embodiments of beverage dispensing systems that can dispense beverages having sufficient carbonation, even while a water tank of the system is being refilled, and that may produce relatively low temperature beverages from relatively high temperature source water.

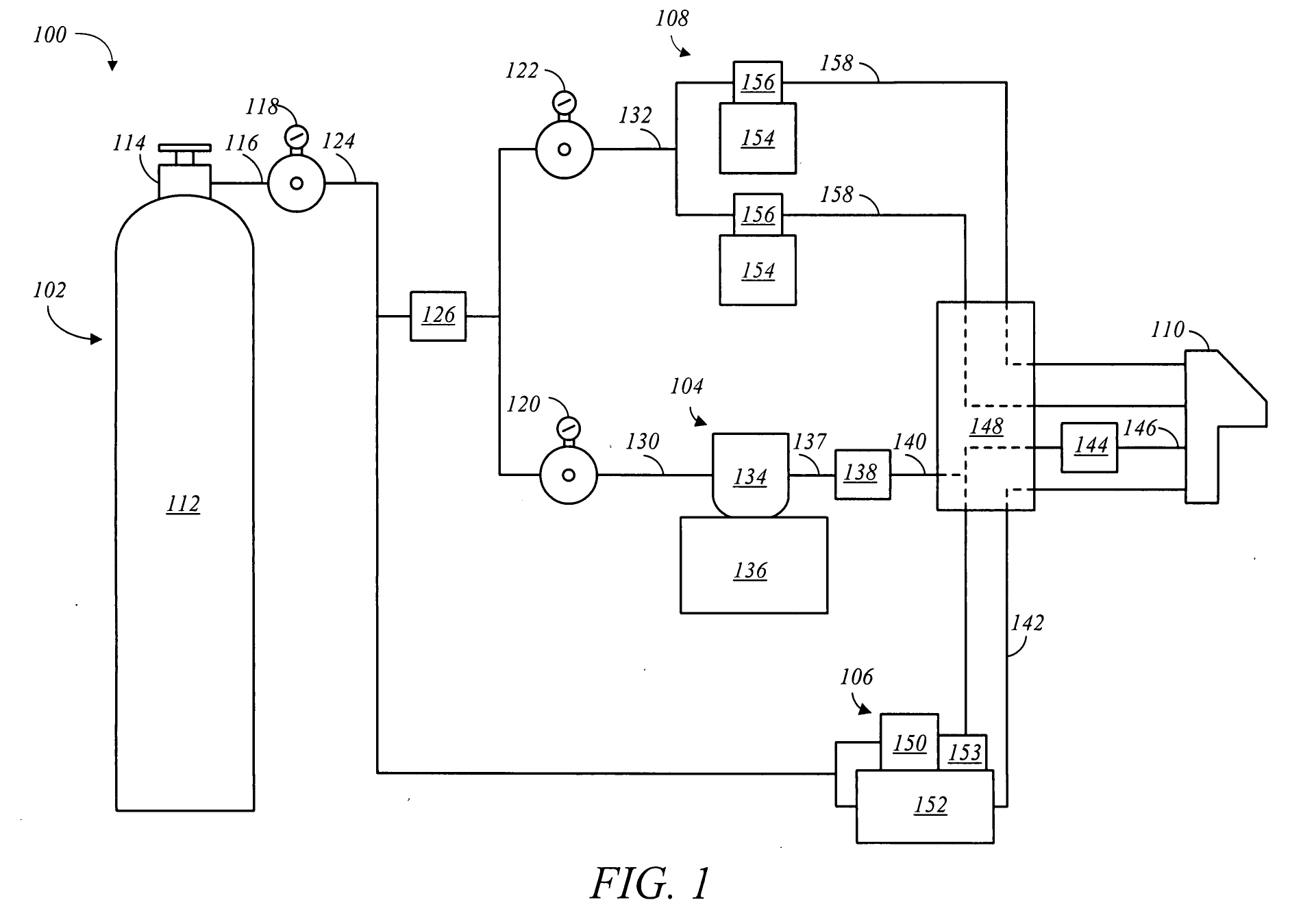

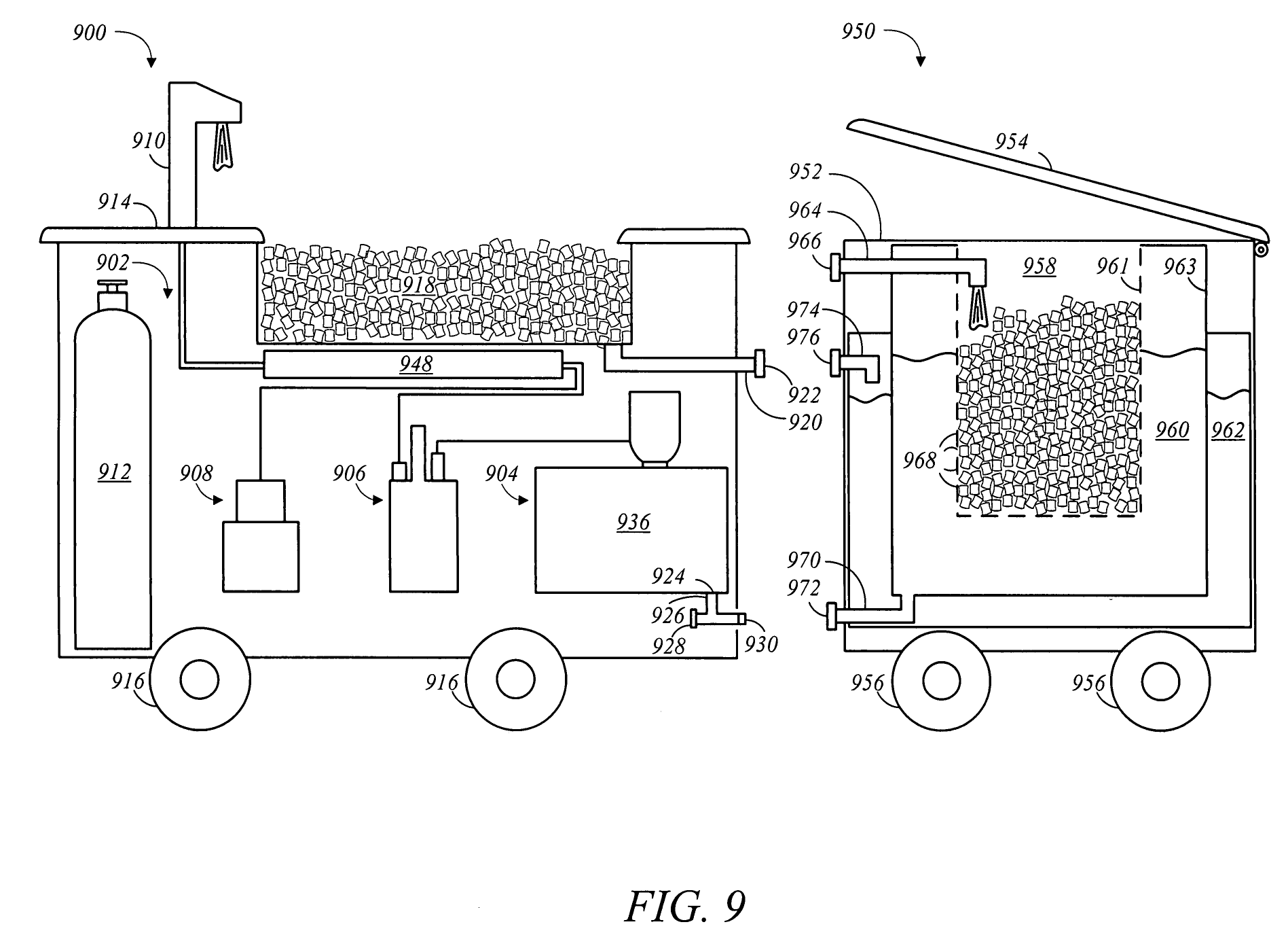

FIG. 1 illustrates a first embodiment of a portable beverage dispensing system 100 that can, for instance, be integrated into a suitable delivery vehicle such as the movable cart shown in FIG. 9. The system 100 generally comprises a source of driving gas 102, a water system 104, a carbonator system 106, a source of liquids 108, and a beverage dispensing valve 110.

The source of driving gas 102 typically comprises a refillable gas storage tank 112 that is filled with a pressurized gas, such as carbon dioxide (CO₂) gas. As is discussed in more detail below, the pressurized gas contained within the gas storage tank 112 is used for various purposes including pressurizing the water system 104 to drive stored water through the system, carbonating water in the carbonator system 106, and pressurizing the source of liquids 108 to drive various stored liquids to the dispensing valve 110.

The pressurized gas exits the gas storage tank 112 through a gas shut-off valve 114. When the gas shut-off valve 114 is open, the pressurized gas travels through a gas outlet 116 and is supplied to one or more gas pressure reducing regulators. A first pressure regulator 118 reduces the pressure, and supplies the gas to a gas supply line 124. The gas supply line 124 transports the gas to the carbonator system 106 and to a manifold 126. The manifold supplies gas to a second pressure regulator 120 and a third pressure regulator 118. Gas traveling through the second pressure regulator 120 is reduced in pressure and then travels along gas supply line 130 to the water system 104. Gas traveling through the third pressure regulator 122 is also selectively reduced in pressure and then travels along gas supply line 132 to the source of liquids 108.

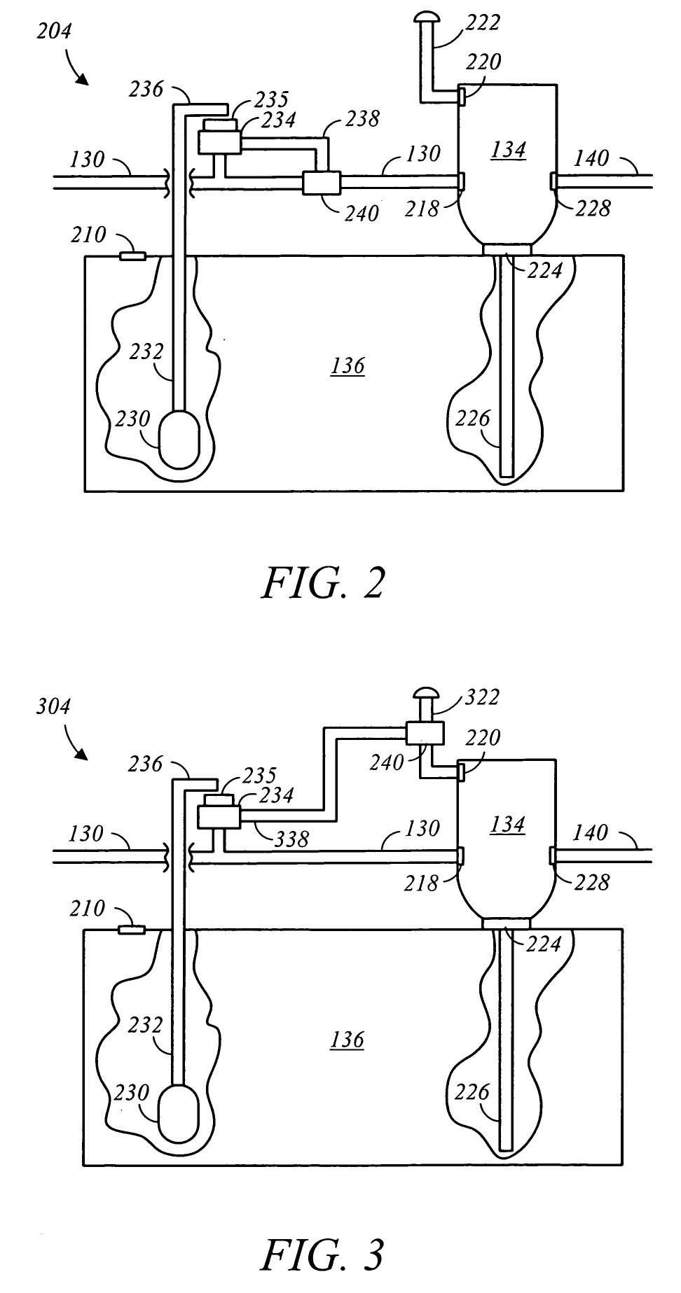

By way of example, the water system 104 comprises a pump 134 and a water tank 136, both of which are described in further detail with reference to FIGS. 2-4. Generally speaking, the water tank 136 stores water for use in dispensing beverages. The pump 134 uses gas supplied along gas supply line 130 to extract water from the water tank, pressurize the water, and supply the water to water supply line 137. Pressure regulator 138 can reduce the pressure of water traveling along water supply line 137. Water supply line 140 transports the pressurized water exiting the pressure regulator 138 through a cold plate 148. Within the cold plate 148, the water supply line 140 splits to transport the water in two separate directions. In a first direction, the water is supplied to the carbonator system 106 that carbonates the water as described below. From the carbonator system, carbonated water supply line 142 transports the carbonated water through the cold plate 148 and to the beverage dispensing valve 110 for use in dispensing carbonated beverages. In a second direction, the pressurized water is supplied to a pressure regulator 144 that reduces the water pressure. From the pressure regulator 144, non-carbonated water supply line 146 transports the non-carbonated water to the dispensing valve 110 for use in dispensing non-carbonated beverages.

The carbonator system 106 comprises a filing system 150, a carbonator tank 152 and a carbonator fill water control valve 153, although other configurations are possible. The carbonator system is described in greater detail below, but generally speaking, gas traveling along gas supply line 124 is supplied to the interior of the carbonator tank to carbonate the water stored in the tank. Gas is also supplied to the filling system 150 for use in sensing and controlling the level of water stored in the tank. In response to the detected fill condition of the carbonator tank 152, the filling system signals a carbonator fill water control valve 153 to open or close. The carbonator fill water control valve 153 controls the flow of water from the water tank 136 into the carbonator tank 152.

The source of liquids includes one or more liquid reservoirs 154 and extraction devices 156 in communication with the reservoirs. By way of example, two such reservoirs and extraction devices are illustrated. As is described in further detail below, gas traveling along gas supply line 132 is supplied to each extraction device, which can extract liquid from its associated reservoir. The extracted liquid travels along liquid supply line 158 to the cold plate 148, which chills the liquid before the liquid is discharged through the beverage dispense valve 110.

FIG. 2 illustrates a first embodiment of a water system 204 that can be used in the beverage dispensing system 100 shown in FIG. 1. Although capable of alternative configurations, the water tank 136 is a rectangular tank constructed of a material such as plastic. The volume of the water tank may be, for instance, approximately 5 gallons or approximately 20 gallons. A vent 210 on the top of the tank maintains the interior of the tank at atmospheric pressure. The water tank can also be configured with a fill and drainage opening on the underside of the water tank, as is described below in connection with FIG. 9.

The pump 134 can comprise a gas-driven pump. Suitable pumps include, for example, KR series pumps manufactured by Heypac Incorporated. Gas from gas supply line 130 is supplied to the gas chamber of the pump through gas inlet opening 218. The gas chamber also has an exhaust gas opening 220 connected to an exhaust line 222. Water is supplied from water tank 136 to the liquid chamber of the pump through hydraulic inlet opening 224, which is in communication with the interior of the water tank via suction inlet tube 226. The suction inlet tube extends to about one-half inch from the bottom of the water tank, such that water enters the tube from the bottom of the water tank. Water exits the liquid chamber of the pump into water supply line 137 through hydraulic output opening 228.

The pump 134 may be configured to cycle in response to a water-pressure decrease in the water supply lines 137 and 140, such as when the filling system 150 senses a low-water condition in the carbonator tank 152 or when a non-carbonated beverage is dispensed from the beverage dispensing valve 110 (FIG. 1). In such a case, the pump 134 cycles by performing an output stroke in which gas flows into the gas chamber through gas inlet opening 218 and water is simultaneously pushed from the liquid chamber into water supply line 137. The pump 134 them performs an input stroke, in which water is pulled into the liquid chamber through suction inlet tube 226. Exhaust gas also exits the gas chamber via exhaust line 222.

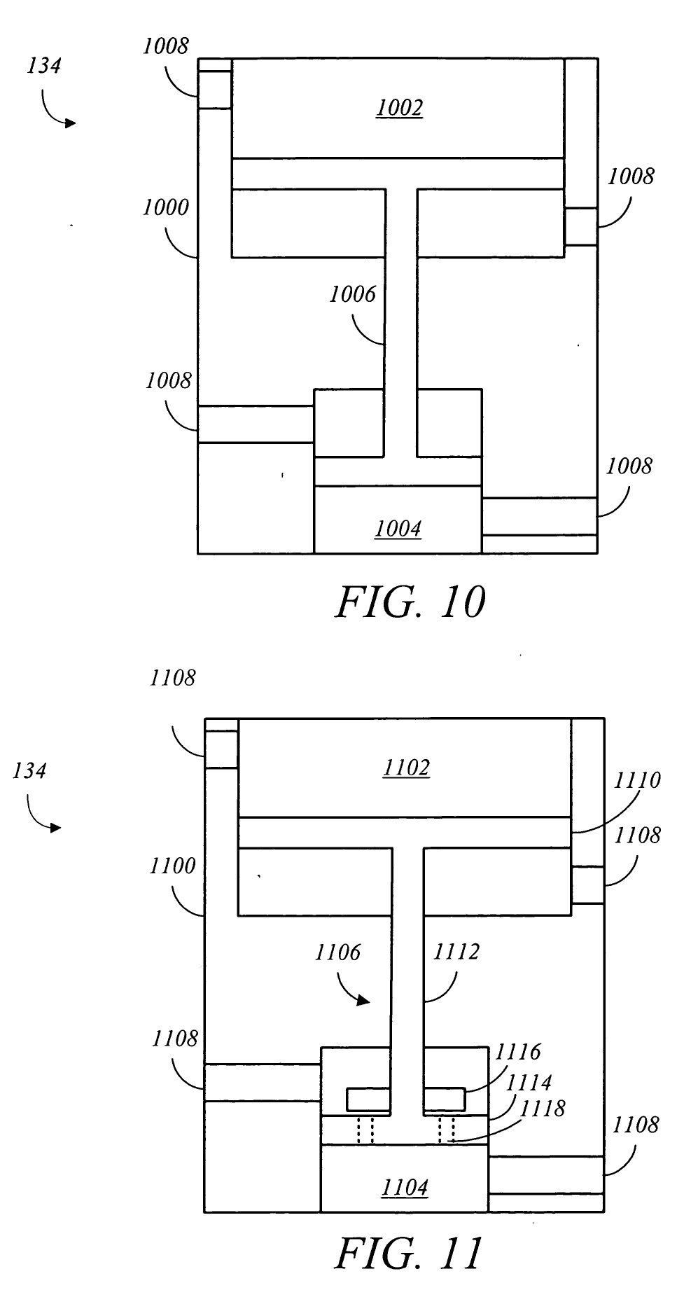

In some embodiments, the pump 134 may be a single-stoke pump 1000 as shown in FIG. 10. The pump 1000 has a gas chamber 1002 and a liquid chamber 1004 separated by a piston 1006. Various openings 1008 allow gas and liquid to enter and exit the chambers 1002 and 1004, as described above.

In some embodiments, the pump 134 can comprise a dual-stroke pump 1100 shown in FIG. 11 that extracts water on both the output and input stroke. Such a pump 1100 has a gas chamber 1102 and a liquid chamber 1104 separated by a piston 1106. The piston 1106 includes a drive piston 1110 within the gas chamber 1102, a fluid piston 1114 within the liquid chamber 1104, and a piston rod 1112 connecting the drive piston and the fluid piston. A valve 1116 is configured to selectively cover holes 1118 in the fluid piston. As the piston 1106 moves down, the valve 1116 does not cover the holes 1118 and fluid moves through the holes. As the piston 1106 moves up, the valve 1116 covers the holes 1118 and liquid cannot move through the holes. Such a pump 1110 allows water to be pushed from the pump during both the output and input strokes.

In either case, the gas chamber of the pump 134 can be larger than the liquid chamber such that the output pressure of water along the water supply line 137 is magnified in comparison to the input pressure of gas along the gas supply line 130. For example, the pump 134 may increase pressure by a factor of five such that the output pressure of water to the water supply line 137 may be about 250 pounds per square inch (psi) in embodiments in which the input pressure of gas along the gas supply line 130 is about 50 psi.

The water system 104 can be configured to automatically interrupt the pump 134 when the water level in the water tank 136 is low, and to automatically reactivate the pump when the water level is restored. In the embodiment shown in FIG. 2, the water system 204 has a float 230 positioned within the interior of the water tank 136 that is coupled to a shaft 232 passing through an opening on the top of the water tank. The shaft 232 can be configured to engage a switch 234 when the float descends to a low water level point. For example, the shaft 232 can have a hooked portion 236 that can contact a trigger 235 on the switch 234 when the water level is low. As shown, the switch 234 can be a pneumatic switch powered by gas diverted from gas supply line 130. The switch 234 is configured in a “normally closed” position, meaning the switch normally prohibits gas from flowing through the switch. When the trigger 235 of switch 234 is activated, such as when the float 230 is at the low water level point, the switch opens and gas is allowed to flow through the switch into gas signal line 238.

A gas signal flowing along gas signal line 238 is transported to a valve 240. For example, the valve 240 can comprise a pneumatic toggle valve having an internal spring. As shown in FIG. 2, the valve 240 is located on gas supply line 130 between the switch 234 and the gas inlet opening 218 of the pump 134. The valve 240 is configured in a “normally open” position, meaning the valve normally allows gas to flow through gas supply line 130 into the pump 134. A gas signal supplied from the switch 234 over the gas signal line 238 may compress the spring to close the valve 240, preventing gas traveling along gas supply line 130 from flowing past the valve and into the pump 134. The gas supply to the pump 134 is interrupted until the water in the water tank 136 rises, causing the float 230 to rise such that the trigger 235 on the switch 234 is released.

In a second embodiment shown in FIG. 3, a water system 304 is configured as shown in FIG. 2, except that instead of placing the valve 240 on the gas supply line 130, the valve is located on the exhaust line 322 adjacent the exhaust gas opening 220. Because the valve 240 is configured in a “normally open” position, exhaust gas can exit the pump through the exhaust line 322. A gas signal sent from the switch 234 on the gas signal line 238 may act on the spring to close the valve 240, blocking the exhaust line. Exhaust gas is prevented from escaping, causing a pressure build-up in the gas chamber of the pump 134. Once the pressure reaches the pressure allowed by the gas pressure regulator 120 on gas supply line 130, the pump 134 cannot cycle until the exhaust gas is released. The pump 134 remains stalled until the water level in the tank 136 rises, such that the float 230 rises and releases the trigger 235 on the switch 234.

It should be noted that results described above with reference to FIGS. 2 and 3 could be accomplished by reversing the configurations of the switch 234 and the valve 240. The switch 234 could be configured in a “normally open” position so that gas normally flows through the switch and over the gas signal line 238 to the valve 240. The valve 240 could be configured in a “normally closed” position, meaning the valve normally prevents gas from flowing through it. Using such configurations does not change the result. In FIG. 2, when the trigger 235 on the switch 234 is not activated, such as when the float 230 is above a low water position, a gas signal is sent through the switch 234 into the valve 240 to keep the valve open. When the trigger 235 on the switch 234 is activated, the switch closes and the gas signal to the valve 240 is interrupted, causing the valve to close to interrupt the gas supply to the pump 134. Similarly, in FIG. 3, when the trigger 235 on the switch 234 is activated, the switch closes, causing the valve to close to prevent exhaust gas from exiting the pump 134.

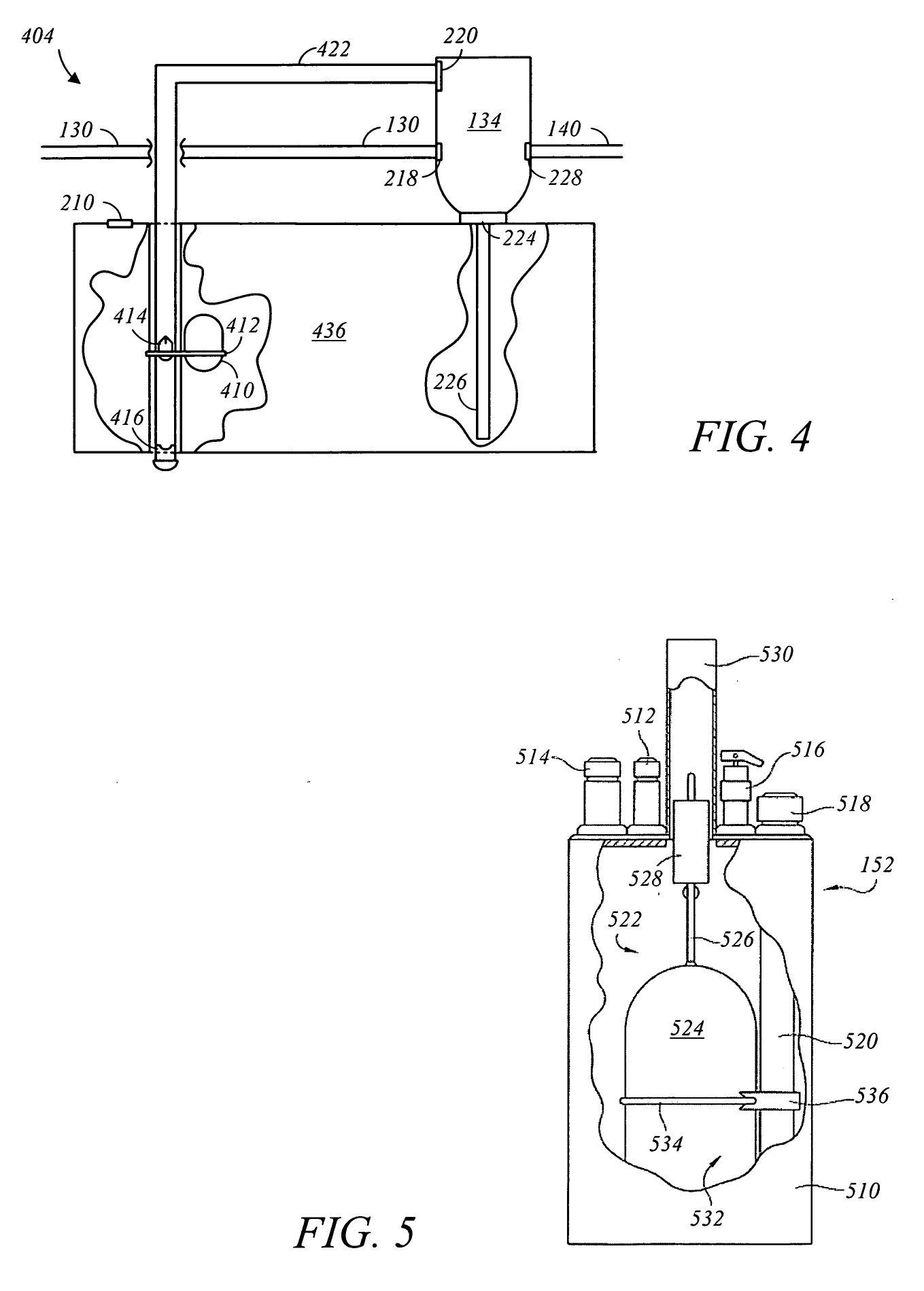

A third embodiment of a water system 404 is illustrated in FIG. 4. The exhaust line 422 passes through a cylindrical opening in the interior of the water tank 436. A magnetic holder 412 is coupled to a float 410 and is mounted to the cylindrical openings such that the magnetic holder can slide with respect to the opening. A magnetic follower 414 disposed within the exhaust line 422 is configured to respond to movement of the magnetic holder 412, and therefore, the float 230. The top of the magnetic follower 414 may have a triangular shape that deflects exhaust gas around the magnetic follower, and the bottom of the magnetic follower may have a bullet shape that complements the shape of a valve seat 416 located adjacent the bottom of the water tank 136. When the float 410 descends to the low water level position, the magnetic follower 414 also descends and becomes seated in the valve seat 416. This closes the valve 416, blocking the flow of exhaust gas along line 422 and stalling the pump 134. Like above, the pump 134 remains stalled until the water level in the tank 436 rises and the magnetic follower 414 is moved from the valve seat 416 is released.

FIGS. 5-7 illustrate an embodiment for the carbonator system 106 that can be used in the beverage dispensing system 100 shown in FIG. 1. It should be noted that alternative configurations for the carbonator system 106 are possible, including the configuration disclosed in assignee's U.S. Pat. No. 6,253,960, which is herein incorporated by reference.

FIG. 5 illustrates a example carbonator tank 152 for use in the carbonator system 106. The carbonator tank 152 comprises a generally cylindrical tank 510. Mounted to the top of the carbonator tank 152 are a gas inlet port 512 that is in fluid communication with gas supply line 124, a water inlet port 514 that is in fluid communication with water supply line 140, and a carbonated water outlet 518 that is in fluid communication with the carbonated water supply line 142 (FIG. 1). Further mounted to the top of the carbonator tank 152 is a safety relief port 516. Inside the carbonator tank 152 is a carbonated water supply tube 520 that extends from the bottom of the tank up to the carbonated water outlet 518 such that, when the dispenser valve 110 is activated to produce carbonated water, the pressurized carbonated water from the bottom of the carbonator tank is forced through the supply tube 520, out of the carbonated water outlet 518, through the carbonated water supply line 142, through the cold plate 148, and finally out of the dispensing valve 110 into the beverage container.

The carbonator tank 152 further comprises a water level indicator 522. This indicator 522 includes a hollow float member 524 having a rod 526 extending upwardly from the top portion of the float member. Positioned on the top of the rod 526 is a magnetically conductive member 528, which can be, for example, a magnetically conductive cylinder. When the carbonator tank 152 is empty, the float member 524 rests on or near the bottom of the carbonator tank. While the tank is situated in this empty configuration, part of the magnetically conductive member 528 is positioned within the tank and part of the magnetically conductive member is positioned within an elongated hollow tube 530 that extends upwardly from the top of the carbonator tank. This hollow tube 530 permits travel of the rod 526 and magnetically conductive member 528 in the upward direction, the purpose for which is explained below.

As the carbonator tank 152 is filled with water, the buoyancy of the float member 524 causes it to float towards the top of the tank. To maintain the float member 524, rod 526, and magnetically conductive member 528 in correct orientation, a mechanical stabilizer 532 can be provided that includes a retainer band 534 that is wrapped around the float member 524 and a slide member 536 that is disposed about the carbonated water supply tube 520. Configured in this manner, the float member 524 will continue to rise within the carbonator tank 152 as the water level within the tank increases. Similarly, the magnetically conductive member 528 will rise within the elongated hollow tube 530 so that water level sensing means can detect when the tank 152 is full, so that water flow into the tank can be halted.

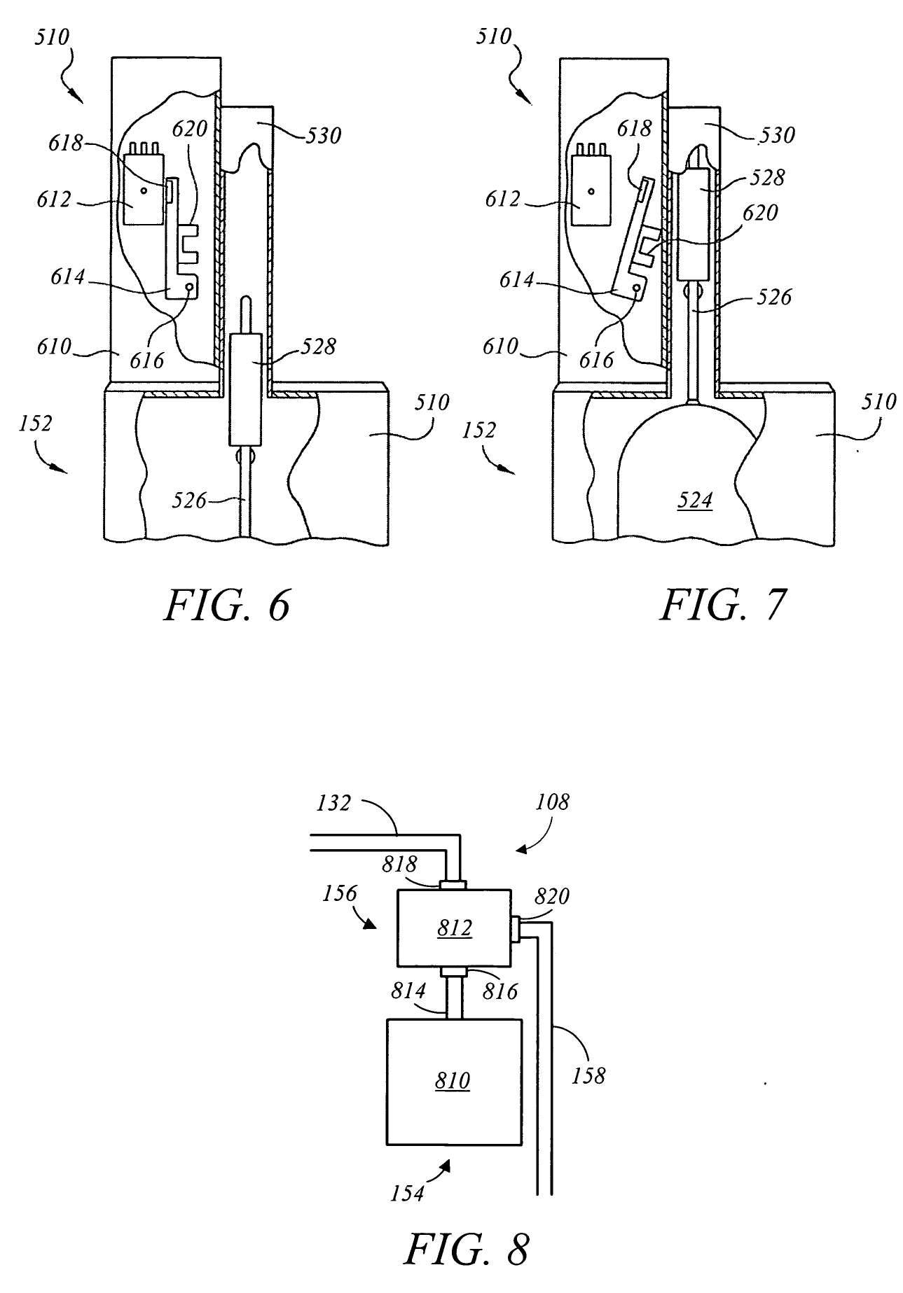

As described above, the water level within the tank 152 can be controlled using the filling system 150. FIGS. 6 and 7 illustrate an example configuration of one such filling system 150. As indicated in these figures, the filling system can comprise an outer housing 610 that is positioned in close proximity to the hollow 530 of the carbonator tank 152. Located within the housing 610 is a pneumatic, magnetic proximity switch 612 and a lever arm 614. Although the proximity switch 612 is fixed in position within the housing 610, the lever arm 614 is free to pivot about a pivot point 616 (e.g., a pin) such that the lever arm is pivotally mounted within the housing. Mounted to the lever arm 614 are first and second magnets 618 and 620. The first magnet 618 is mounted to the arm 614 at a position at which it is adjacent the proximity switch 612 when the lever arm is vertically oriented as shown in FIG. 6.

Because the first magnet 618 is attracted to the proximity switch 612, the first magnet maintains the lever arm 614 in a vertical orientation when the tank 152 is not full. When the lever arm 614 is in this vertical orientation, positive contact is made with the proximity switch 612, thereby activating the switch and causing it to send a signal to the water control valve 153, shown in FIG. 1.

For instance, in FIG. 1 the water control valve 153 is a pneumatically actuated valve that can be opened or closed to permit or prevent the flow of water into the tank 152. By way of example, the water control valve 153 comprises a normally closed, gas-actuated valve. A pneumatic pressure signal from the proximity switch 612 opens the valve so that the carbonator tank 152 can be filled.

As the water level rises, however, the magnetically conductive member 528 within the hollow tube 530 rises, eventually moving to a position in which it is adjacent the second magnet 620 mounted on the lever arm 614. Since the magnetically conductive member 528 is constructed of a magnetically conductive metal, such as magnetically conductive stainless steel, the second magnet 620 of the lever arm 614 is attracted to the member. In that the attractive forces between the second magnet 620 and the magnetically conductive member 528 are greater than those between the first magnet 618 and the proximity switch 612, the lever arm 614 pivots toward the magnetically conductive member as depicted in FIG. 7. By pivoting in this direction, contact between the first magnet 618 and the proximity switch 612 is interrupted, thereby deactivating the proximity switch and shutting the supply of pressurized gas to the water control valve 153, causing the normally closed valve to interrupt the flow of water to the carbonator tank 152.

FIG. 8 illustrates an embodiment of the source of liquids 108 that can be used to supply drink concentrates within the beverage dispensing system 100 shown in FIG. 1. By way of example, the liquid reservoir 154 can comprise a conventional “bag-in-box” container 810, and the extraction device 156 can comprise a pneumatic vacuum pump 812. The bag-in-box container 810 can be a cardboard box that holds a pliable bag filled with, for example, soft drink syrup and/or juice concentrate. Such containers 810 are often used by drink manufacturers to supply drink concentrates that can be combined with water. Each bag-in-box container 810 has a corresponding pump 812, and a suction line 814 connecting the bag-in-box container to an inlet 816 of the pump. Each pump 812 has an interior diaphragm operably connected to an inner reversible valve (not shown). Pressurized gas supplied over gas supply line 132 to the pump via gas inlet 818 can reciprocate the diaphragm back and forth under the control of the reversible valve, drawing syrup or juice concentrate through the liquid outlet 820 of the pump into the liquid supply line 158. The gas supplied by gas supply line 132 may be at a varying pressure determined by gas pressure regulator 122, such that a single gas supply line 132 can be used with a multitude of bag-in-box containers 810 having drink concentrates of varying viscosity. As mentioned above, the liquid supply line 158 transports the contents of the containers through the cold plate 148 and to the beverage dispensing valve 110, as is shown in FIG. 1. When the pressure of the gas supplied by line 132 equals the pressure in the line 158, the pump 810 will stall to interrupt the reciprocation of the pump 810. When the pressure becomes unequal, such as when the pressure in line 158 drops as syrup or concentrate is dispensed through the beverage dispensing valve, the pump 810 will again reciprocate to draw and expel liquids along the liquid supply line 158. Presently deemed suitable for the described use is a Model 5000 vacuum pump available from Flowjet.

Although the source of liquids 108 is described as comprising a bag-in-box container and a vacuum pump in the foregoing, it is to be appreciated that equivalent substitutes to either or both of these components could be used. Depending on the number of types of beverages to be supplied from the beverage dispensing valve 110, a plurality of bag-in-box containers can be used, with each box supplying a distinct type of drink concentrate. Further, in embodiments not shown, the source of liquids 108 can have other configurations that may or may not include bag-in-box containers and vacuum pumps. For example, the source of liquids 108 may comprise the refillable container unit which is described in Assignee's U.S. Pat. No. 6,820,763, which is hereby incorporated by reference.

The operation of the beverage dispensing system 100 will now be described, with reference back to FIG. 1. The system 100 can dispense carbonated and/or non-carbonated beverages using pressurized gas instead of electricity. The gas used by the system can be stored in gas storage tank 112. Gas flows from gas storage tank 112 into the first pressure regulator 118, which regulates the gas pressure to, for instance, approximately 90 psi. From the first pressure regulator 118, gas flows over gas supply line 124 into both the carbonator system 106 and the manifold 126, which supplies gas to the second pressure regulator 120 and to the third pressure regulator 122. The second pressure regulator 120 regulates the gas pressure to, for instance, approximately 50 psi and supplies the gas to the water system 104 using gas supply line 130. The third pressure regulator 122 selectively regulates the gas pressure to, for instance, approximately 40 to 80 psi and supplies the gas to the source of liquids 108 over gas supply line 132. The variable gas pressure accommodates the varying viscosities of drink concentrates supplied by the source of liquids.

The water system 104 uses gas to drive the pump 134. The pump 134 extracts water from water tank 136 and pressurizes the water to a sufficient pressure for use in the carbonator system 106, as described below. With reference to FIG. 2, the pump 134 is a pneumatic pump that extracts water from near the bottom of water tank 136 through suction inlet tube 226 and pressurizes the water such that the water will adequately accept carbonation. In some embodiments, the pump 134 can increase the output pressure of the water in comparison to the input pressure of the gas by, for instance, a factor of five. For example, in cases in which the input gas pressure is about 50 psi and the pump 134 increases the pressure by a factor of five, the output water pressure can be about 250 psi.

Using a pump 134 that pressurizes the water obviates the need to pressurize the water tank 136 itself. For example, the water tank 136 illustrated in FIG. 2 is not pressurized, with vent 210 maintaining the interior of the pump at atmospheric pressure. Because the water tank 136 is not pressurized, the water tank can be refilled or emptied without disrupting the operation of the beverage dispensing system 100 in general. Additionally, a beverage dispensing system having such a pump 134 uses relatively less gas to extract and pressurize water than a system in which the entire water tank is pressurized. Therefore, the gas storage tank 112 is relatively less likely to be depleted and can be refilled relatively less often.

The cycling of the pump 134 can be interrupted when the water level in the water tank 136 is low, so that the pump is not damaged. In the embodiment shown in FIG. 2, the float 230 communicates the water level in the tank to the hooked portion 236 of the shaft 232, and when the water level reaches a low water level point, the hooked portion engages the switch 234. The normally closed switch 234 opens, and a gas signal is sent along gas signal line 238 to the pneumatic valve 240. In response to the gas signal, the normally-open pneumatic valve 240 closes to interrupt the gas supply to the pump 134 until the water level in the tank 136 rises and the hooked portion is removed from the switch 234 by the rising float 230.

In the embodiment shown in FIG. 3, the float 230 communicates the water level in the tank to the hooked portion 236 of the shaft 232, and when the water level reaches a low water level point, the hooked portion engages the switch 234. The normally closed switch 234 opens such that a gas signal is sent along gas signal line 338 to the pneumatic valve 240. In response to the gas signal, the normally closed pneumatic valve 240 opens, causing gas to be transported into exhaust line 322 that prevents the exhaust gas from escaping from the pump 134. The pump 134 stalls until the water level in the tank 136 rises and the hooked portion is removed from the switch 234 by the rising float 230.

In the embodiment shown in FIG. 4, float 410 communicates the water level in the tank 436 to the magnetic follower 414 within the exhaust line 422 via the magnetic holder 412. When the water level is above the low water level point, exhaust gas is routed past the triangular-shaped top of the magnetic follower 414, down the exhaust line 422, and out of the valve seat 416. When the water level descends to the low water level point, the magnetic follower 414 becomes seated in the valve seat 416, blocking the exhaust line 422. The pump 436 stalls until the water level in the tank 436 rises and the magnetic follower 414 is removed from the valve seat 416 by the rising float 410.

With reference back to FIG. 1, the pump 134 supplies pressurized water to the carbonator system 106. Relatively pressurized and chilled water may accept carbonation more readily than water that has not been pressurized or chilled. For example, water may adequately accept carbonation at a pressure of about 150 psi. Therefore, water from the pump traveling along water supply line 137 may have a pressure of about 250 psi. Water pressure regulator 138 may regulate the pressure to about 150 psi. Water supply line 140 then transports the water through the cold plate 148 before delivering the water into the carbonator system 106.

The carbonator system 106 also receives gas over gas supply line 124 for use in carbonating water in the carbonator tank 152 and for running the filling system 150. Gas flows into the carbonator tank 152, raising the pressure within the tank to, for instance, approximately between 80 psi to 125 psi, which may be a suitable pressure to carbonate the water stored therein. In addition, gas is directed to the filling system 150 and is used, as needed, to send pneumatic pressure signals to the water control valve 153.

The filling of the carbonator tank 152 will be described with reference to FIGS. 5-7. Assuming the carbonator tank 152 initially does not contain water, the float member 524 contained therein is positioned near the bottom of the tank and the switch 612 is in the activated position shown in FIG. 6. Because the switch 612 is in this activated position, pneumatic pressure is provided to the water control valve 153, keeping it in the open position so that water can flow into the carbonator tank 152 (FIG. 1). As the water continues to flow from the water tank 136, the pressure of the water begins to rise sharply. Eventually, the pressure of the water in the carbonator tank 152 reaches a pressure equal to that of the gas provided to the tank. Since the carbonator tank 152 is relatively small as compared to the gas storage tank 212 and the water tank 136, the carbonator tank fills quickly. Therefore, carbonated water is available soon after the system 100 is initiated.

Once the carbonator tank 152 is full, the switch 612 becomes oriented in the inactivated position shown in FIG. 7, shutting off the supply of gas to the water control valve 153. Without the pressure signal needed to remain open, the water control valve 153 closes, cutting the supply of water to the carbonator tank 152. As the water level within the carbonator tank 152 is again lowered, the switch 612 is again activated, restarting the process described above. The system 100 therefore cycles in response to the volume of water contained in the carbonator tank 152. For example, the switch 612 may become activated when a set volume of water, such as approximately 12 ounces of water, have exited the carbonated tank 152. The cycle repeatedly occurs during use of the system 100 until either the gas or water supplies are depleted. At this time, either or both may be refilled, and the system 100 reinitiated.

With reference to FIG. 1, carbonated water exiting the carbonator tank 152 travels along carbonated water supply line 142, and again passes through cold plate 148 before entering the beverage dispensing valve 110. The carbonator system 106 may have reduced the water pressure to, for instance, about 110 psi. Such pressure may be adequately low for dispensing from the beverage dispensing valve 110, which may be strained by higher-pressure fluids.

In some cases, the beverage dispensing 110 valve uses non-carbonated water to produce non-carbonated beverages. To supply the beverage dispensing valve 110 with such non-carbonated water, water supply line 140 branches within the cold plate 148. One branch of water supply line 140 passes through water pressure regulator 144, which reduces the water pressure to prevent strain on the beverage dispensing valve 110. For example, the pressure may be reduced from about 150 psi to about 50 psi. After the non-carbonated passes water through the pressure regulator 144, it enters the beverage dispensing valve 110.

The dispensing valve 110 mixes the carbonated or non-carbonated water with drink concentrates supplied from the source of liquids 108, such as soft drink syrups and/or juice concentrates. For this reason, the source of liquids 108 operates simultaneously with the water system 104 and the carbonator system 106. Specifically, when a beverage is dispensed from the beverage dispensing valve 110, a pressure imbalance is created in the pump 156 that causes the pump to reciprocate. In embodiments in which the pump 156 is the pneumatic vacuum pump 810 shown in FIG. 8, the pump uses gas to extract liquid from the bag-in-in box container 810 via suction line 814 and to push the liquid into liquid supply line 158. The liquid is chilled by cold plate 148 before passing into beverage dispensing valve 110, which combines the liquid with either carbonated or non-carbonated water, as is appropriate. When the bag-in-box container is empty, it may be replaced with a fresh container and the depleted container may be thrown away.

When the system 100 is initiated by opening the gas shut-off valve 114 of the gas storage tank 112, the beverage dispensing valve 110 may not be able to dispense beverages because the carbonated water supply line 142 may not contain carbonated water, the non-carbonated water supply line 146 may not contain non-carbonated water, or the liquid supply lines 158 may not contain liquids. Each fluid deficiency is accompanied by a low-pressure condition along a corresponding water or liquid supply line, and a component or components of the system 100 may cycle to correct the low-pressure condition. The cycling may continue until the pressure reaches the pressure required by the applicable pressure regulator, and the fluid deficiency in the supply line is corrected. The system 100 is then ready for operation. After the system 100 is initialized, dispensing a beverage from the beverage dispensing valve 110 creates a pressure imbalance in one or more supply lines, depending on the nature of the dispensed beverage. The components of the system 100 may again cycle until the pressure imbalance is rectified.

FIG. 9 illustrates a serving module 900 and a water refill module 950. The serving module 900 may be used to dispense beverages using an embodiment of the beverage dispensing system described above or any other beverage dispensing system. The water refill module 950 may be used to refresh a water system of the serving module with reduced temperature water.

The serving module 900 comprises a cart 914 that houses a beverage dispensing system 902. As shown, the system 902 is an embodiment of the beverage dispensing system 100 described above. An interior of the cart 914 houses components of the system 902 including a water system 904, a carbonator system 906, a source of liquids 908, a gas storage tank 912, and a cold plate 948. A beverage dispensing valve 910 that communicates with the internal components is mounted to an exterior of the cart.

The cart 914 can be mounted on wheels 916 so that the beverage dispensing system is moveable. The cart may be motorized or pushed by hand. In embodiments not shown, the wheels 916 can be substituted with casters or other transport mechanisms that are known in the art, or the wheels may be omitted completely.

An ice reservoir 918 that is configured to hold ice is formed in an exterior of the cart. The reservoir can hold ice that can be included with a dispensed beverage. A drain tube 920 communicates with a lower portion of the reservoir and with the exterior of the cart 914, such that melted ice can be removed from the ice reservoir. The drain tube 920 can have a connector 922, such as a quick connect fitting, that is configured to connect the drain tube to the water refill module 950, for reasons described below.

Located on the interior of the cart adjacent the ice reservoir 918 is the cold plate 948. The cold plate 948 can be, for instance, an aluminum mass having stainless steel tubing embedded within the mass. Ice in the adjacent ice reservoir 918 can reduce the temperature of the aluminum mass, and therefore liquids passing through the tubing. For example, water such as carbonated water and non-carbonated water, and drink concentrates such as soft-drink syrups and juice concentrates, can be routed through the cold plate 948 before entering the beverage dispensing valve 910.

A fill and drainage opening 924 on the underside of the water tank 936 can be used to fill and drain the water tank. The fill and drainage opening 924 is connected to a t-fitting 926 having a shut-off valve 928 used to drain the tank 936 and a quick connect fitting 930 used to fill the tank. The tank 936 can be filled by connecting the quick connect fitting 930 to a hose that supplies water under pressure, or by connecting the quick connect fitting to the water refill module that supplies water under the force of gravity, as is described below.

As shown in FIG. 9, the water refill module 950 comprises a cart 952 having a lid 954 and wheels 956. The cart 952 can be a push cart or a motorized cart. In embodiments not shown, the wheels may be substituted for casters or other transport mechanisms. In still other embodiments, the water refill module 950 need not comprise a cart 950, in which case the module may be stationary and the wheels may be omitted.

Three receptacles are formed in an interior of the cart including an ice receptacle 958, a clean water receptacle 960, and a refuse water receptacle 962. The receptacles can be concentric such that the inner ice receptacle 958 sits within the intermediate clean water receptacle 960, and the intermediate clean water receptacle 960 sits within the outermost refuse water receptacle 962. The receptacles can be box-shaped having rectangular surfaces made from stainless steel, although other materials and shapes can be used. For example, the receptacles can be cylindrically shaped. Also, the shape of one receptacle can differ from the shape of another, or differing shapes can be used for the interior and exterior surfaces of a single receptacle. For example, the clean water receptacle can have an exterior surface that is cylindrically shaped and an interior surface that is a truncated sphere.

An interior surface 961 of the clean water receptacle 960 forms the boundary of the ice receptacle 958. The ice receptacle 958 is configured to hold, for instance, 10 gallons of ice, which is loaded through an opening on the top of the ice receptacle.

Water can be transported into the ice receptacle 958 using inlet passage 964. The inlet passage 964 can have a quick connect fitting 966 that is configured to connect the inlet passage to a water system. The inlet passage 964 can be, for example, a duct extending between an opening on the exterior surface of the cart 952 and an opening on an upper portion of the interior surface 961. The inlet passage 964 may extend through the clean water receptacle 960, such as in embodiments in which the clean water receptacle is closed on top.

The interior surface 961 of the clean water receptacle 960 has perforations 968 that place the ice receptacle 958 in fluidic communication with the clean water receptacle. The perforations 968 can be, for instance, slits, holes, or mesh, although the perforations can be any configuration that allow fluid to flow from the ice receptacle 958 into the clean water receptacle 960. While the perforations 968 can be many sizes, as shown the perforations are smaller than a piece of ice such that water can flow through the perforations but ice cannot.

The clean water receptacle 960 is configured to contain, for example, 20 to 25 gallons of water and can measure, for example, 18 inches by 18 inches by 20 inches. Water can be communicated out of the clean water receptacle 960 using outlet passage 970. For example, the outlet passage 970 can be a duct extending between an opening on a lower portion of the exterior surface 963 of the clean water receptacle 960 and an opening on the exterior surface of the cart 952. A quick connect fitting 972 is configured to connect the outlet passage 972 to the quick connect fitting 930 of the water tank 936 on the serving module 900.

The exterior surface 963 of the clean water receptacle 960 is in thermally conductive communication with refuse water receptacle 962. For example, the exterior surface 963 can be a stainless steel wall that forms the interior surface of the refuse water receptacle 962. The exterior surface 963 may be impervious to liquid such that the contents of the clean water receptacle 960 are kept separate from the contents of the refuse water receptacle 962. An inlet passage 974 can communicate refuse water into the refuse water receptacle 960. For example, the inlet passage 974 can be a duct extending from an opening on the exterior surface of the cart into the refuse water receptacle 962. A quick connect fitting 976 is configured to connect the inlet passage 974 to the quick connect fitting 920 on the drain tubing 922 of the ice reservoir 918 of the serving module 900. Although other configurations are possible, the refuse water receptacle 962 substantially surrounds a lower portion of the clean water receptacle 960 and does not penetrate a height greater than the lowest portion of the ice reservoir 918. For example, the refuse water receptacle 962 may have dimensions of 23 inches by 23 inches by 16 inches.

The operation of the water refill module 950 will now be described. The water refill module 950 is configured to supply reduced temperature water to the water tank 936 of the serving module 900. The lid 954 of the cart 952 is removed and ice is placed into the ice receptacle 958 through the opening. The lid 954 can then be replaced to limit debris from entering the ice receptacle 958. The quick connect fitting 966 connects the inlet passage 964 of the ice receptacle 958 to a water source, such as a hose supplying pressurized water. The temperature of the water from the water source may be higher than the temperature desired for use in the water tank 936 of the serving module.

In embodiments in which the inlet passage 964 is coupled to an upper portion of the ice receptacle 958, the water descends over the ice under the force of gravity, reducing the temperature of the water. The reduced-temperature water flows through the perforations 968 in the interior surface 961 separating the ice receptacle 958 and the clean water chamber 960.

The quick connect fitting 972 of the outlet passage 970 is connected to the quick connect fitting 930 that is in communication with the fill and drainage opening 924 of the water tank 936 of the serving module 900. In embodiments in which the outlet passage 970 is coupled to a lower portion of the clean water receptacle 960, the reduced-temperature water flows from the clean water receptacle 960 into the water tank 936 under the force of gravity.

In embodiments having a refuse water receptacle 962, melted ice from the ice reservoir 918 of the serving module 900 can be employed to mitigate the effect of the ambient temperature on the water stored in the clean water receptacle 960. The temperature of the water may rise in cases in which the ambient temperature is higher than the water temperature. Melted ice from the ice reservoir 918 is drained into the refuse water receptacle 962 by connecting the quick connect fitting 976 of the inlet passage 974 to the quick connect fitting 922 on the drain tube 920. The refuse water receptacle 918 maintains the melted ice apart from the water in the clean water receptacle, while allowing the melted ice to accept heat from the water through the thermally conductive exterior surface 963. The melted ice can be drained under the force of gravity in cases in which the drain tube 920 is coupled to the underside of the ice reservoir 918, the inlet passage 976 is coupled to the upper portion of the refuse water receptacle, and the refuse water receptacle is lower than the ice reservoir.

Although the water refill module 950 and its various components have been described above as being configured for use with water, it will be understood that the refill module can be used to chill fluids other than water. Further, the clean water receptacle 960 can be used in conjunction with a different fluid than the fluid in refuse water receptacle 962, and in some embodiments, the refuse water receptacle 962 can be omitted completely, in which case the inlet passage 974 and the quick connect fitting 976 can also be omitted.

The serving module 900 and the water refill module 950 can be used together or separately. In some embodiments, the serving module 900 can be used without the water refill module 950, in which case the water tank 936 is refilled using a source of pressurized water, such as a hose. In other embodiments, the water refill module 950 can be used without the serving module for other applications requiring the use of chilled fluid. In still other embodiments, the serving module 900 and the water refill module 950 may be used simultaneously, in which case the two modules remain connected via the fittings 922, 930, 972, and 976. It may be advantageous to use both modules simultaneously in embodiments in which the water tank 936 holds a relatively small volume, such as 5 gallons. Because the water tank 936 is not pressurized, the water tank can be refilled even as beverages are dispensed.

Using the serving module 900 and the water refill module 950 as described above enables dispensing beverages having a relatively high level of carbonation and a relatively low temperature without the use of electricity. For example, the dispensed beverage may have be carbonated such that about 3.5% or greater of the volume of the beverage is dispersed carbon dioxide and the beverage has a temperature of about 40° F. or lower. The carbonation can be achieved as described above in connection with the carbonation system. For example, in embodiments in which the water is chilled and regulated to a pressure of about 150 psi before being carbonated, the water may accept carbonation more effectively. The temperature can be achieved by using the water refill module 950 and the cold plate 948. For example, the water refill module may reduce the water temperature from above 90° F. to about 50° F., and the cold plate may reduce the water temperature from about 50° F. to a final temperature of about 32° F.

While particular embodiments of a beverage display system and a beverage cart have been disclosed in detail in the foregoing description and drawings for purposes of example, those embodiments are mere implementations of the disclosed systems and carts. Variations and modifications may be made to the embodiments without departing from the scope of the disclosure.

At least the following is claimed:

1. A beverage dispensing system comprising:
a source of pressurized gas;
a water system including a water tank that stores water, and a pneumatic pump driven by gas from the source of pressurized gas to pull water from the water tank into the pump and push water from the pump;
a carbonator system that creates carbonated water using water from the pump and gas from the source of pressurized gas; and
a beverage dispensing valve that dispenses the carbonated water.

2. The beverage dispensing system of claim 1, wherein the water tank stores water at about atmospheric pressure, such that the tank can be refilled without disrupting the operation of the system.

3. The beverage dispensing system of claim 1, wherein the pneumatic pump is configured to increase pressure such that the output water pressure is greater than the input gas pressure.

4. The beverage dispensing system of claim 1, wherein the pneumatic pump is a dual-stroke pneumatic pump that is configured to pump water during an both an input stroke and an output stroke.

5. The beverage dispensing system of claim 1, wherein the pneumatic pump comprises:
a gas chamber in fluidic communication with the source of pressurized gas;
at least one liquid chamber in fluidic communication with the water tank; and
a piston separating the gas chamber and the at least one liquid chamber.

6. The beverage dispensing system of claim 5, wherein the at least one liquid chamber has a smaller volume than the gas chamber such that the pressure of the liquid exiting the pump exceeds the pressure of the gas entering the pump.

7. The beverage dispensing system of claim 5, wherein the piston further comprises holes in the portion of the piston that is within the liquid chamber, the holes being selectively covered by a valve, such that the pump is configured to extract liquid during an input and an output stroke of the pump.

8. The beverage dispensing system of claim 1, wherein the water system is configured to interrupt the pneumatic pump when the water level in the water tank is low and to reactivate the pump when the water level is restored.

9. The beverage dispensing system of claim 1, wherein the water system further includes:
a switch that is activated when the water level in the water tank is low, and
a valve that responds to the switch to interrupt the pump until the switch is deactivated.

10. The beverage dispensing system of claim 9,
wherein the switch is a pneumatic switch in communication with the source of pressurized gas, the switch opening when activated so that a gas signal is sent through the switch to the valve; and
wherein the valve is a pneumatic toggle valve in communication with the switch and located on a gas supply line that supplies gas to the pump, the valve closing in response to a gas signal from the switch so that the gas supply line into the pump is blocked by the valve when the switch is activated.

11. The beverage dispensing system of claim 9, wherein:
the switch is a pneumatic switch in communication with the source of pressurized gas, the switch opening when activated so that a gas signal is sent through the switch to the valve; and
the valve is a pneumatic toggle valve in communication with the switch and located on an exhaust line that allows exhaust gas to exit the pump, the valve closing in response to a gas signal from the switch so that exhaust gas is prevented from exiting the pump.

12. The beverage dispensing system of claim 1, wherein the water system further includes:
an exhaust line coupled to the pump and passing through an opening in the water tank,
a float disposed in the interior of the water tank and coupled to a magnetic holder that is slidably mounted around the exhaust line,
a magnetic follower disposed in the exhaust line that is magnetically attracted to the magnetic holder such that the magnetic follower rises and falls with the float, and
a valve located on the exhaust line and having a complementary shape to the magnetic follower, such that when the float descends to a low water level, the magnetic follower becomes seated in the valve to block the exhaust line and stall the pump.

13. The beverage dispensing system of claim 1, wherein the pneumatic pump increases the pressure of the water to about 150 psi such that the water entering the carbonator is adequately pressurized to accept carbonation.

14. The beverage dispensing system of claim 1, further comprising:
a water pressure regulator between the pneumatic pump and the carbonator system, wherein the pneumatic pump increases the pressure of the water to above 150 psi, and the water pressure regulator regulates the pressure of the water to about 150 psi, such that the water entering the carbonator is adequately pressurized to accept carbonation.

15. The beverage dispensing system of claim 1, further comprising:
a cold plate between the pump and the carbonator system, wherein the cold plate reduces the temperature of the water, such that the water is adequately conditioned to accept carbonation.

16. The beverage dispensing system of claim 1, further comprising:
a source of liquids including a liquids reservoir that stores drink concentrate, and an extraction device driven by gas from the source of pressurized gas to extract drink concentrate from the liquid reservoir,
wherein the beverage dispensing valve is configured to dispense a beverage that includes the carbonated water and the drink concentrate.

17. A system for reducing the temperature of a fluid comprising:
an ice receptacle configured to hold ice;
a fluid chamber having a shared surface with the ice receptacle, the shared surface having perforations that place the ice receptacle in fluidic communication with the fluid chamber; and
an outlet passage that places the fluid chamber in fluidic communication with an exterior of the system,
wherein the system is configured to reduce the temperature of fluid placed into the ice receptacle with ice and to provide the fluid to an exterior of the system using the perforations and the outlet passage.

18. The system of claim 17, wherein the fluid chamber includes an interior surface that substantially encloses the fluid chamber, the interior surface forming the boundary of the ice receptacle and having the perforations that place the ice receptacle in fluidic communication with the fluid chamber.

19. The system of claim 1, further comprising:
a first inlet passage that places the exterior of the system in fluidic communication with the ice receptacle,
wherein the system is configured to reduce the temperature of fluid from the exterior of the system that is passed into the ice receptacle using the first inlet passage.

20. The system of claim 17,
wherein the first inlet passage comprises a duct extending between the exterior of the system and an opening on an upper portion of the interior surface of the fluid chamber; and
wherein the outlet passage comprises a duct extending between an opening on a lower portion of an exterior surface of the fluid chamber and the exterior of the system; and
wherein the system is configured to use the force of gravity to reduce the temperature of fluid and to provide the fluid to the exterior of the system by accepting the fluid into an upper portion of the ice receptacle, allowing the fluid to descend over the ice, and passing the fluid out of the lower portion of the fluid chamber.

21. The system of claim 20, further comprising:
an outer receptacle in thermally conductive communication with the fluid chamber; and
a second inlet passage that places the exterior of the system in fluidic communication with the outer receptacle;
wherein the system is configured to minimize the effect of relatively high temperature ambient air on the fluid in the fluid chamber by allowing a second fluid having a relatively low temperature to be passed into the outer receptacle using the second inlet passage such that the second fluid can be placed in thermally conductive communication with the fluid in the fluid chamber.

22. The system of claim 21, further comprising:
a cart that substantially houses the ice receptacle, the fluid chamber, and the outer receptacle, the cart defining the boundary of the exterior of the system; and
wheels coupled to a lower portion of the cart.

23. A system for reducing the temperature of a fluid comprising:
a first module that includes an ice receptacle configured to hold ice, a first fluid chamber having a perforated shared surface with the ice receptacle that places the fluid chamber in fluidic communication with the ice receptacle, and a first outlet passage that places the fluid chamber in fluidic communication with an exterior of the first module; and
a second module that includes a second fluid chamber configured to receive the fluid, and a second inlet passage that places an exterior of the second module in fluidic communication with the second fluid chamber, the second inlet passage being configured to connect to the first outlet passage,
wherein when fluid and ice are placed in the ice receptacle and the first outlet passage is connected to the second outlet passage, the system is configured to reduce the temperature of the fluid and to supply the fluid to the second fluid chamber by allowing the fluid to move over the ice, through the perforations, and along the first outlet and second inlet passages.

24. The system of claim 23, wherein the second module further includes a beverage dispensing system, the second fluid chamber being a water tank of the beverage dispensing system.

25. The system of claim 23, wherein the first outlet passage is positioned on a lower portion of the first fluid chamber and is vertically higher than the second inlet passage, such that the system is configured to move the fluid from the first fluid chamber to the second fluid chamber under the force of gravity.

26. The system of claim 23,
wherein the second module further includes a source of refuse fluid, and a second outlet passage that places the source of refuse fluid in fluidic communication with the exterior of the second module;
wherein the first module further includes a receiver of refuse fluid that is in thermally conductive communication with the first fluid chamber, and a first inlet passage that places the exterior of the first module in fluidic communication with the receiver of refuse fluid, the first inlet passage being configured to connect to the second outlet passage; and
wherein when the source of refuse fluid contains relatively low-temperature fluid and the second outlet passage is connected to the first inlet passage, the system is configured to place the refuse fluid in thermally conductive communication with the fluid in the fluid chamber by allowing the refuse fluid to move from the source of refuse fluid through the passages and into the receiver of refuse fluid.

27. The system of claim 26, wherein the second module further includes a beverage dispensing system, the second fluid chamber being a water tank of the beverage dispensing system and the source of refuse fluid being an ice reservoir of the beverage dispensing system.

28. The system of claim 26, wherein the source of refuse fluid is vertically higher than the receiver of refuse fluid, the second outlet passage is positioned on a lower portion of the source of refuse fluid, the first inlet passage is positioned on an upper portion of the receiver of refuse fluid, and the receiver of refuse fluid substantially surrounds a lower portion of the first fluid chamber, such that the system is configured to use the force of gravity to move the refuse fluid from the source of refuse fluid to the receiver of refuse fluid.

29. The system of claim 23, wherein the first module further includes a third inlet passage that places the exterior surface of the first module in fluidic communication with the ice receptacle, such that the system is configured to reduce the temperature of fluid passed into the ice receptacle from an exterior of the system using the third inlet passage.

30. The system of claim 29, wherein the third inlet passage is positioned on an upper portion of the ice receptacle, and is vertically higher than the first outlet passage, such that the system is configured to use the force of gravity to move fluid from the third inlet passage to the first outlet passage.

31. The system of claim 23, wherein the exterior of the first module comprises a first cart, the first module further includes wheels coupled to the first cart, the exterior of the second module comprises a second cart, and the second module further includes wheels coupled to the second cart.
